(19) United States
(12) Patent Application Publication
(10) Pub. No.: US 2008/0050568 A1
(43) Pub. Date: Feb. 28, 2008

(54) Backing film, fabrication method thereof, and tape utilizing the same

(75) Inventors: Lucky Lee, Hsinchu City (TW); Tai Hsun Lee, Taoyuan County (TW); Ching-Chih Lai, Hsinchu (TW); Yan-sheng Yang, Hsinchu City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/892,631

(22) Filed: Aug. 24, 2007

(30) Foreign Application Priority Data
Aug. 24, 2006 (TW) 95131084

(51) Int. Cl. B32B 7/02; B32B 27/32; B32B 7/12; C08J 3/22; C08L 9/00; D01D 5/12

(52) U.S. Cl. 428/213; 264/210.1; 264/469; 428/220; 428/354; 524/525; 525/232

(57) ABSTRACT

The invention provides a tape film backing including a mixing layer comprising 40-60 parts by weight of PE and 60-40 parts by weight of EPDM rubber and a PE layer. The invention also provides a tape with an adhesive layer coated on the mixing layer or the PE layer of the tape film backing. The tape and the film backing is a halogen-free eco-material possessing superior physical properties as well as fine electrical insulating properties.

### BACKGROUND OF THE INVENTION

1. Field of the Invention

The invention relates to a tape backing film, and in particular to the electrical insulation properties thereof.

2. Description of the Related Art

Polyvinyl chloride (PVC) is popular for use as electrical insulating film due to its low cost, simple processing, heat resistance, and flame retardant properties. Recently, however, use of environmentally friendly materials has gained attention. The European Union has released a directive for Reduction of Hazardous Substances (RoHS), promoting use of lead-free and halogen-free materials in electronic device manufacture. Thus, manufacture of electrical insulating tape increasingly focuses on use of environmentally friendly materials to replace chlorine-containing PVC.

Taiwan Patent Application No. 092123541 discloses a tape backing film comprising a blend of ethylene propylene diene monomer (EPDM) rubber and polyethylene (PE), with optional employment of processing aids such as colorants, dyes, ultraviolet (UV) stabilizers, plasticizers, germicides, antioxidants, or wax.

Similar to U.S. Pat. No. 6,106,941, U.S. Pat. No. 6,287,685 discloses a tape comprising an EPDM rubber layer in the outer side, such that small molecule migration still occurs when the film is exposed to heat, a phenomenon often referred to as “blooming.”

Accordingly, conventional tape cannot resolve the problem of small molecules of EPDM rubber migrating to the tape surface after heating, and thus a tape backing film without sacrificing electrical insulation and tensile strength is called for.

### BRIEF SUMMARY OF THE INVENTION

A detailed description is given in the following embodiments with reference to the accompanying drawings.

The invention provides a tape backing film comprising at least two layers, wherein a first layer comprises polyethylene (PE); and a second layer comprises a blend of polyethylene and EPDM rubber, wherein the first layer is coated on the second layer.

The invention also provides a tape comprising the described tape backing film with an adhesive coated on the first layer surface or the second layer surface.

The invention further provides a method of manufacturing a tape backing film comprising a blend of polyethylene and EPDM rubber; forming a mixing layer by melting the blend; forming a thick film by molding a polyethylene layer and the mixing layer, wherein the polyethylene layer is coated on the mixing layer; forming a thin film by drawing the thick film; and performing a surface treatment on the thin film.

### BRIEF DESCRIPTION OF THE DRAWINGS

The invention can be more fully understood by reading the subsequent detailed description and examples with references made to the accompanying drawings, wherein:

FIG. 1 is a cross section of a double layer tape backing film of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As used herein, the term “tape” is meant to indicate electrical insulation tape.

As used herein, the term “film” is meant to indicate the matrix for lately coated adhesive;

As used herein, the term “breakdown voltage” is meant to indicate the minimum voltage to break the tape;

As used herein, the term “thickness ratio” is meant to indicate the thickness ratio of different layers in back film;

The second layer of the tape backing film of the invention is a blend of EPDM rubber and PE. Suitable PE includes low density PE (LDPE), high density PE (HDPE), or linear low density PE (LLDPE). The PE may have a molecular weight of about 50,000 g/mol to 300,000 g/mol, or about 100,000 g/mol to 200,000 g/mol, and comprise about 40-60 parts by weight of the mixing layer. The EPDM rubber may include 50-90 parts by weight of ethylene, 5-50 parts by weight of propylene, and 0-3 parts by weight of diene, and about 60-40 parts by weight of the mixing layer.

The first layer of PE may also be low density PE (LDPE), high density PE (HDPE), or linear low density PE (LLDPE). The PE of the first layer also may have a molecular weight of about 50,000 g/mol to 300,000 g/mol, or about 100,000 g/mol to 200,000 g/mol.

The tape backing film of the invention can optionally have added to it about 0.05-20 parts by weight of a flame retardant; about 0.05-15 parts by weight of a colorant or a dye; about 0.05-30 parts by weight of a filler such as SiO₂, TiO₂, CaCO₃, MgCO₃, CaSO₄, BaSO₄, Al₂SiO₅, or the like; and about 0.05-10 parts by weight of a processing aid such as demolding agent, coupling agent, lubricant, UV stabilizer, plasticizer, germicide, antioxidant, or wax.

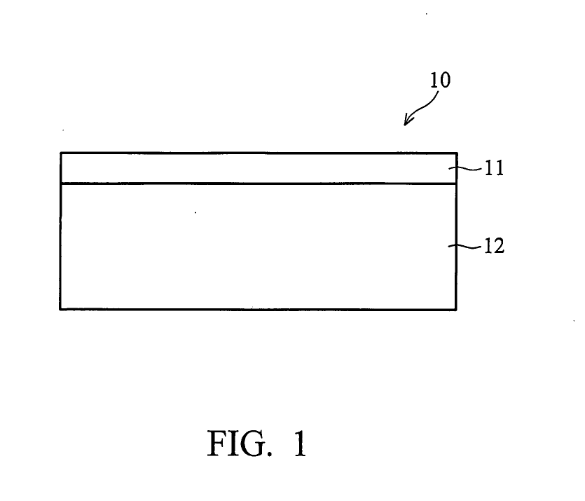

As shown in FIG. 1, the PE layer 11 is coated on the mixing layer 12. The thickness of the PE layers 11 may generally be about ⅕ to 1/20 of the total tape backing thickness. Note that the thickness ratio of the mixing layer 12 to tape backing film 10 relates to the EPDM rubber ratio of the mixing layer 12. EPDM rubber ratio and related thickness of the mixing layer 12 can be modified as is known in the art. Overall thickness of the tape backing film 10 is preferably about 0.02 to 0.30 mm.

The tape backing film of the invention has a tensile strength of 1.05 to 2.5 kgf/mm², an elongation at break of 100% to 800%, a breakdown voltage of 39 to 150 kv/mm, and a recovery from deformation of 10 to 20%, similar to PVC film and EPDM rubber/PE single layer film, with breakdown voltage of the film of the invention exceeding that of the PVC. After heating for extended periods, the small molecules of EPDM rubber do not migrate to the surface of the film, with no corresponding cracking. Analysis of the stress-strain test of the film of the invention shows stretching and contracting similar to a PVC film. The film of the invention, while indiscernible from conventional PVC film in properties such as elasticity, robustness, and shrinkage, is halogen free and easily recovered, and may completely replace the PVC tape and EPDM rubber/PE single layer tape backing film.

In fabrication of the tape backing film according to the invention, the disclosed PE and EPDM rubber are blended with fillers, processing aids, or additives in a mixer or an extruder. Mixing parameters are not limited, although mixing rate is generally higher for better results. The blending ratio of parts by weight for PE/EPDM can be 40/60, 50/50, 60/40, and other suitable ratio.

While the mixture can be directly used to form film, it can also be pelletized before sequential processes for convenience of storage and machine operations. The pellets can be formed by twin screw extrusion at about 100 to 240° C.

The mixture or pellets may be melted at about 220 to 280° C. to form a mixing layer. The mixing layer may be formed by, for example, single screw extrusion molding, twin screw extrusion molding, or calendaring. When using single screw extrusion, the screw has a preferable length to diameter ratio of about 30. A PE layer can be coated on the mixing layer, and then molded at, for example, 170 to 320° C. to form a thick film. The molding method includes multi-layer co-extrusion and single layer extrusion.

Next, the thick film may be drawn to form a thin film with stretch ratio in a longitudinal direction is about 1:1 to 1:10, or 1:1 to 1:5; and stretch ratio in a transverse direction about 1:1 to 1:10, preferably 1:1 to 1:5, respectively. After drawing, the thin film has physical properties similar to PVC backing film.

The thin film may be optionally subjected to a surface treatment to form the tape backing film of the invention. The surface treatment improves the surface adhesion of the film to subsequently formed adhesives. Non-limiting examples of suitable surface treatments include corona treatment (for example, 1000 to 5000 volt/cm²) or chemical treatment (for example, coating a primer). The tape backing film may have a thickness of about 0.02 to 0.30 mm, or 0.08 to 0.20 mm.

The PE layer or the mixing layer of the tape backing film disclosed may be uniformly coated with a layer of polymeric pressure sensitive adhesive (PSA), such as acrylic adhesive or rubber adhesive, for instance with a thickness of about 0.01 to 0.05 mm and adhesive force of about 1.4 to 5.8 kgf/19 mm, similar to conventional PVC tape, while remaining halogen free. Other adhesives known in the art may also be employed. Note that if adhesive is coated on the first layer (PE layer), the surface treatment needs a primer coating after corona treatment. On the other hand, if adhesive is coated on the second layer (mixing layer), the primer coating can be ignored. Because the primer coating contains high ratio solvent, adhesive coated on the second layer is free of solvent problems such as industrial safety and environment protection.

### EXAMPLES AND COMPARATIVE EXAMPLES

### Example 1

100 parts by weight of PE (C7100, produced by Asia Polymer Co., Taiwan), 80 parts by weight of EPDM rubber (Nordel 1070, produced by DuPont), 10 parts by weight of a filler, 4 parts by weight of a colorant, and 0.5 parts by weight of an antioxidant were placed in a mixer and mixed at high speed, and then pelletized by a twin screw extruder at 190° C. The resulting pellets were placed in a single screw extruder with a screw of 90 mm in diameter, ratio of screw length to screw diameter (L/D) of 30, and a die of 400 mm in diameter at 220 to 280° C. to undergo extrusion to form a mixing film. A PE layer was coated on the mixing film and then molded to form a thick film (double layer). The thick film was drawn at a stretch ratio of 1:3 in a longitudinal direction and at a stretch ratio of 1:4 in a transverse direction to form a thin film of 0.15 mm thickness. The thin film was subjected to corona treatment at 2000 v/cm² to form the tape backing film of the invention.

Comparison 1

100 parts by weight of PE (C7100, produced by Asia Polymer Co., Taiwan), 118 parts by weight of EPDM rubber (Nordel 1070, produced by DuPont), 4 parts by weight of a processing aid, and 2 parts by weight of a colorant were placed in a mixer and mixed at high speed, and then pelletized by a twin screw extruder at 190° C. The resulting pellets were placed in a single screw extruder with a screw of 90 mm in diameter, ratio of screw length to screw diameter (L/D) of 30, and a die of 400 mm in diameter at 220 to 280° C. to undergo extrusion to form a mixing film (single layer). The mixing film was drawn at a stretch ratio of 1:3 in a longitudinal direction and at a stretch ratio of 1:4 in a transverse direction to form a thin film of 0.15 mm thickness. The thin film was subjected to corona treatment at 2000 v/cm² to form a tape backing film.

Test

Tensile strength, elongation at break, breakdown voltage, deformation set, and heat resistance of Example 1 and Comparison 1 were respectively tested according to the UL-510 standard, with results shown in Table 1.

TABLE 1

| | Tensile | Elongation | Breakdown | Deformation | Heat | Small |
|---|---|---|---|---|---|---|
| | Strength | at break | voltage | set | resistance | molecules |
| Test items | (kgf/mm²) | (%) | (kV/mm) | (%) | (87° C. * 1440 hr) | migration |
| UL-510 | 1.05 | 100 | 39 | — | No cracking | — |
| qualified standard | | | | | and corrosion | |
| PVC | 2.5 | 124 | 79 | 9-12 | Qualified | None |
| Comparison | 1.3 | 620 | 78.7 | 11-13 | Unqualified | Appeared |
| Example 1 | 2.1 | 620 | 84.6 | 12-14 | Qualified | None |

As shown, the physical properties of Example 1 (double layer) are better than that of Comparison 1 (single layer of EPDM rubber/PE). In particular, Comparison 1 exhibits cracking and corrosion after heating for extended periods. Compared to Comparison 1, the tensile strength of Example 1 is more similar to PVC backing film. In addition, the breakdown voltages of Example 1 exceed that of the PVC backing film. Accordingly, Example 1 has better physical properties than the EPDM rubber/PE single layer backing film of Comparison 1.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the claims should be accorded the broadest interpretation so as to encompass all such modifications and similar arrangements.

What is claimed is:

1. A tape backing film, comprising
a first layer comprising polyethylene (PE); and
a second layer comprising a blend of polyethylene (PE) and ethylene propylene diene monomer (EPDM) rubber;
wherein the first layer is coated on the second layer.

2. The tape backing film according to claim 1, wherein the first layer has a thickness of ⅕ to 1/20 of the tape backing film thickness.

3. The tape backing film according to claim 1, wherein the polyethylene of the first layer or the polyethylene of the second layer comprises high density polyethylyene (HDPE), low density polyethylene (LDPE), linear low density polyethylene (LLDPE), or mixtures thereof.

4. The tape backing film according to claim 1, wherein the PE of the first layer or the PE of the second layer has a molecular weight of 50,000 g/mol to 300,000 g/mol.

5. The tape backing film according to claim 1, wherein the PE of the first layer or the PE of the second layer has a molecular weight of 100,000 g/mol to 200,000 g/mol.

6. The tape backing film according to claim 1, wherein the EPDM rubber comprises about 50-95 parts by weight of ethylene, about 5-50 parts by weight of propylene, and about 0-3 parts by weight of diene.

7. The tape backing film according to claim 1, wherein the second layer comprises about 40-60 parts by weight of polyethylene and about 60-40 parts by weight of EPDM rubber.

8. The tape backing film according to claim 1, further comprising 0.05 to 20 parts by weight of a flame retardant.

9. The tape backing film according to claim 1, further comprising 0.05 to 15 parts by weight of a colorant

10. The tape backing film according to claim 1, further comprising 0.05 to 30 parts by weight of a filler.

11. The tape backing film according to claim 1, further comprising 0.05 to 10 parts by weight of a processing aid.

12. The tape backing film according to claim 1, wherein said tape backing film has a heat resistance of 87° C. for 60 days.

13. The tape backing film according to claim 1, wherein said tape backing film has a tensile strength of 1.05 to 2.5 kgf/mm².

14. The tape backing film according to claim 1, wherein said tape backing film has an elongation at break of 100% to 800%.

15. The tape backing film according to claim 1, wherein said tape backing film has a breakdown voltage of 39 to 150 kv/mm.

16. The tape backing film according to claim 1, wherein said tape backing film has a recovery from deformation of 10 to 20%.

17. The tape backing film according to claim 1, wherein said tape backing film has a thickness of 0.02 to 0.30 mm.

18. A tape, comprising:
a tape backing film, comprising
a first layer comprising polyethylene (PE); and
a second layer comprising a blend of polyethylene and ethylene propylene diene monomer (EPDM) rubber;
wherein the first layer is coated on the second layer; and
an adhesive coated on the first layer or the second layer.

19. A method of manufacturing a tape backing film, wherein said method comprises:
melting a blend of PE and EPDM rubber;
melting PE;
extruding the blend of PE and EPDM rubber;
coating the extruded PE and EPDM rubber with melted PE;
molding the coated PE and EPDM rubber to form a tape backing film; and
drawing the tape backing film.

20. The method according to claim 19, wherein molding is performed at about 170° C. to 320° C.

21. The method according to claim 19, wherein extruding comprises multi-layer co-extrusion or single layer extrusion.

22. The method according to claim 19, wherein drawing comprises drawing the tape backing film at a stretch ratio of 1:1 to 1:10 in two perpendicular directions.

23. The method according to claim 19, wherein the blend of PE and EPDM comprises 40-60 parts by weight of PE and 60-40 parts by weight of EPDM rubber.

24. The method according to claim 19, further comprising treating a surface of said tape backing film, which comprises corona treatment or chemical treatment.

25. The method according to claim 19, wherein extruding comprises single screw extrusion molding, twin screw extrusion molding or calendaring.

26. The method according to claim 25, wherein extruding comprises single screw extrusion molding with a screw, wherein the screw has a length to diameter ratio of about 30.

27. The method according to claim 19, wherein the blend of PE and EPDM is a pellet prior to melting.

28. The method according to claim 27, wherein the pellet is formed by a twin screw extruder.
